(19) United States
(12) Patent Application Publication
(10) Pub. No.: US 2024/0152806 A1
(43) Pub. Date: May 9, 2024

(54) METHOD, APPARATUS, DEVICE AND MEDIUM FOR GENERATING NEGATIVE SAMPLE PAIR FOR CONTRASTIVE LEARNING MODEL

(71) Applicant: Beijing Youzhuju Network Technology Co., Ltd., Beijing (CN)

(72) Inventors: Hao WU, Beijing (CN); Cheng YANG, Beijing (CN)

(21) Appl. No.: 18/388,078

(22) Filed: Nov. 8, 2023

(30) Foreign Application Priority Data
Nov. 8, 2022 (CN) 202211396002.8

(51) Int. Cl. G06N 20/00

(52) U.S. Cl. CPC G06N 20/00

(57) ABSTRACT

A solution for generating a negative sample pair of a contrastive learning model is provided. In one method, a first data segment is obtained from a first data sequence in a plurality of data sequences for training the contrastive learning model, and a second data segment is obtained from a second data sequence in the plurality of data sequences. A data frame is selected from a further data sequence than the second data sequence in the plurality of data sequences. A third data segment is generated based on the second data segment and the data frame. A negative sample pair for training the contrastive learning model is determined based on the first data segment and the third data segment. Therefore, richer semantic information can be introduced into negative sample pairs in terms of appearance, and further the accuracy of the contrastive learning model can be improved.

### FIELD

Example implementations of the present disclosure generally relate to machine learning, and in particular, to a method, apparatus, device, and computer readable storage medium for generating a negative sample pair of a contrastive learning model.

### BACKGROUND

In self-supervised learning, manual labeling of samples is not required. Positive and negative samples corresponding to the samples can be constructed by modifying the samples. Furthermore, positive and negative samples can be used to train the contrastive learning model. The quality and quantity of negative samples greatly affect the performance of the contrastive learning model, which in turn affects the performance of downstream models that call the contrastive learning model. At this time, how to generate suitable negative samples so as to improve the accuracy of the contrastive learning model has become an urgent problem to be solved.

### SUMMARY

In a first aspect of the present disclosure, a method of generating a negative sample pair of a contrastive learning model is provided. In the method, a first data segment is obtained from a first data sequence in a plurality of data sequences for training the contrastive learning model, and a second data segment is obtained from a second data sequence in the plurality of data sequences. A data frame is selected from a further data sequence than the second data sequence in the plurality of data sequences. A third data segment is generated based on the second data segment and the data frame. A negative sample pair for training the contrastive learning model is determined based on the first data segment and the third data segment.

In a second aspect of the present disclosure, an apparatus for generating a negative sample pair of a contrastive learning model is provided. The apparatus comprises: an obtaining module, configured to obtain a first data segment from a first data sequence in a plurality of data sequences for training the contrastive learning model, and obtain a second data segment from a second data sequence in the plurality of data sequences; a selecting module, configured to select a data frame from a further data sequence than the second data sequence in the plurality of data sequences; a generating module, configured to generate a third data segment based on the second data segment and the data frame; and a determining module, configured to determine a negative sample pair for training the contrastive learning model based on the first data segment and the third data segment.

In a third aspect of the present disclosure, an electronic device is provided. The electronic device comprises: at least one processing unit; and at least one memory coupled to the at least one processing unit and storing instructions to be executed by the at least one processing unit, the instructions, when executed by the at least one processing unit, causing the device to perform a method in the first aspect.

In a fourth aspect of the present disclosure, a computer readable storage medium is provided, having a computer program stored thereon, the computer program, when executed by a processor, performing a method in the first aspect.

It would be understood that the content described in the Summary section of the present disclosure is neither intended to identify key or essential features of implementations of the present disclosure, nor is it intended to limit the scope of the present disclosure. Other features of the present disclosure will be readily envisaged through the following description.

### BRIEF DESCRIPTION OF THE DRAWINGS

Through the detailed description with reference to the accompanying drawings, the above and other features, advantages, and aspects of respective implementations of the present disclosure will become more apparent. The same or similar reference numerals represent the same or similar elements throughout the figures, wherein:

FIG. 1 shows a schematic diagram of an example environment in which implementations of the present disclosure can be applied;

FIG. 2 shows a block diagram of a process of training a contrastive learning model according to a technical solution;

FIG. 3 shows a block diagram of a process for generating a negative sample pair of a contrastive learning model according to some implementations of the present disclosure;

FIG. 4 shows a block diagram of a process for generating a noise data frame according to some implementations of the present disclosure;

FIG. 5 shows a block diagram of a process for generating a noise data frame according to some implementations of the present disclosure;

FIG. 6 shows a block diagram of a process for generating a data frame in a third data segment according to some implementations of the present disclosure;

FIG. 7 shows a block diagram of a process for generating a data frame in a third data segment according to some implementations of the present disclosure;

FIG. 8 shows a block diagram of a process for generating a negative sample pair according to some implementations of the present disclosure;

FIG. 9 shows a block diagram of a process for adjusting the sampling frequency of a data segment according to some implementations of the present disclosure;

FIG. 10 shows a flowchart of a method of generating a negative sample pair of a contrastive learning model according to some implementations of the present disclosure;

FIG. 11 shows a block diagram of an apparatus for generating a negative sample pair of a contrastive learning model according to some implementations of the present disclosure; and

FIG. 12 shows an electronic device capable of implementing one or more implementations of the present disclosure.

### DETAILED DESCRIPTION

Implementations of the present disclosure will be described in more detail below with reference to the accompanying drawings. Although some implementations of the present disclosure are shown in the drawings, it would be understood that the present disclosure can be implemented in various forms and should not be interpreted as limited to the implementations described herein. On the contrary, these implementations are provided for a more thorough and complete understanding of the present disclosure. It would be understood that the drawings and implementations of the present disclosure are only for the purpose of illustration and are not intended to limit the scope of protection of the present disclosure.

In the description of implementations of the present disclosure, the term “comprising”, and similar terms should be understood as open inclusion, i.e., “comprising but not limited to”. The term “based on” should be understood as “at least partially based on”. The term “one implementation” or “the implementation” should be understood as “at least one implementation”. The term “some implementations” should be understood as “at least some implementations”. Other explicit and implicit definitions may also be comprised below.

It is understandable that the data involved in this technical proposal (comprising but not limited to the data itself, data obtaining, use, storage, or deletion) shall comply with the requirements of corresponding laws, regulations, and relevant provisions.

It is understandable that before using the technical solution disclosed in respective implementations of the present disclosure, users shall be informed of the type, using scope, and using scenario of personal information involved in the present disclosure in an appropriate way, and be authorized by users according to relevant laws and regulations.

For example, in response to receiving a proactive request from a user, prompt information is sent to the user to explicitly remind the user that a requested operation will require the obtaining and use of personal information of the user, so that the user may independently choose, according to the prompt information, whether to provide personal information to electronic devices, applications, servers or storage media and other software or hardware that perform operations of the technical solution of the present disclosure.

As an optional but non-limiting implementation, in response to receiving a proactive request from a user, the way of sending prompt information to the user may be, for example, a popup window, in which the prompt information may be presented in the form of text. In addition, the popup window may further carry a selection control for the user to choose “agree” or “disagree” to provide personal information to electronic devices.

It is understandable that the above process of notifying and obtaining user authorization is only for the purpose of illustration and does not imply any implementations of the present disclosure. Other ways, to satisfy the requirements of relevant laws and regulations, may also be applied to implementations of the present disclosure.

As used herein, the term “in response to” is to represent a state in which a corresponding event occurs or a condition is satisfied. It will be understood that the timing of the subsequent action performed in response to the event or a condition may not be strongly correlated with the time when the event occurs or the condition is satisfied. For example, in some cases, the subsequent action may be performed immediately when the event occurs or the condition is satisfied; in other cases, the subsequent action may be performed after a period after the event occurs or the condition is satisfied.

### Example Environment

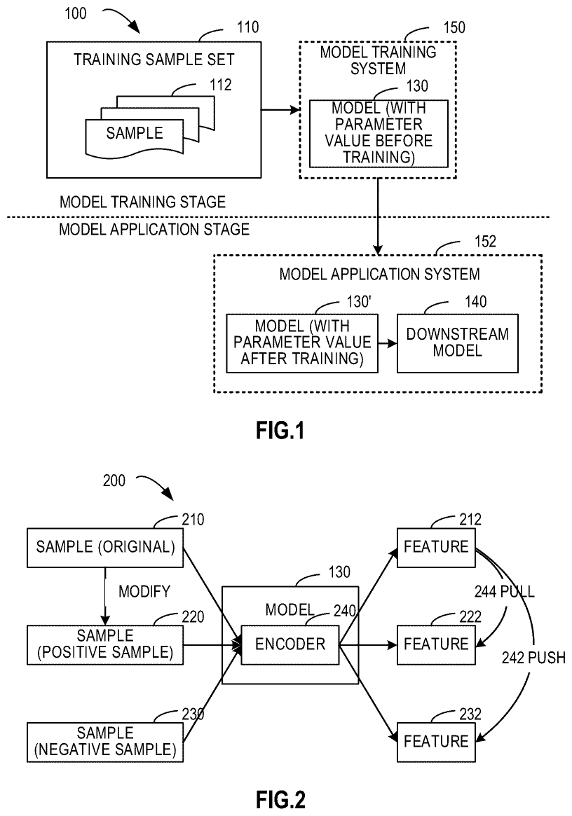

FIG. 1 shows a block diagram of an example environment 100 in which implementations of the present disclosure can be implemented. In the environment 100 of FIG. 1, it is desirable to train and use such a machine learning model (i.e., a model 130). The model is configured for a variety of application environments, e.g., for identifying similarities in videos, etc. As shown in FIG. 1, the environment 100 comprises a model training system 150 and a model application system 152. The upper part of FIG. 1 shows a process of a model training phase, and the lower part shows a process of a model application phase. Prior to training, a parameter value of the model 130 may have an initial value or may have a pre-trained parameter value obtained through a pre-training process. The model 130 may be trained via forward propagation and backward propagation, during which the parameter value of the model 130 may be updated and adjusted. A model 130′ may be obtained after training is completed. At this point, the parameter value of the model 130′ has been updated, and based on the updated parameter value, the model 130 may be used to implement prediction tasks during the model application phase.

During the model training phase, the model 130 may be trained with the model training system 150, based on a sample set 110 comprising a plurality of samples 112. In contrastive learning, positive and negative samples may be constructed respectively with the plurality of samples 112, and the training process may be performed iteratively with a large number of samples. After training is completed, the model 130 may comprise knowledge associated with tasks to be processed. During the model application phase, the model 130′ (at this time, the model 130′ has a trained parameter value) may be called with the model application system 152. Further, a downstream model 140 may be called after the model 130′ to perform specific tasks.

In FIG. 1, the model training system 150 and the model application system 152 may comprise any computing system having computing power, such as various computing devices/systems, terminal devices, servers, etc. Terminal devices may involve any type of mobile terminal, fixed terminal, or portable terminal, comprising a mobile phone, a desktop computer, a laptop computer, a notebook computer, a netbook computer, a tablet computer, a media computer, a multimedia table, or any combination thereof, comprising accessories and peripherals of these devices or any combination thereof. Servers comprise but are not limited to a mainframe, an edge computing node, a computing device in a cloud environment, etc.

It should be understood that the components and arrangements in the environment 100 shown in FIG. 1 are merely examples, and a computing system suitable for implementing the example implementations described herein may comprise one or more different components, other components, and/or different arrangements. For example, although shown as separate, the model training system 150 and the model application system 152 may be integrated into the same system or device. Implementations of the present disclosure are not limited in this regard. Example implementations of the model training and the model application will continue to be described respectively below with reference to the accompanying drawings.

For the sake of description, video processing is used only as the application environment of the contrastive learning model in the present disclosure. The contrastive learning model can be used to perform video self-supervision tasks. For example, a video sequence set to be used as samples may be obtained, and samples can be constructed with respective video sequences in the video sequence set.

FIG. 2 shows a block diagram 200 of a process of training a contrastive learning model according to a technical solution. As shown in FIG. 2, an original sample 210 can be determined from a video, and a sample 220 (i.e., positive sample) can be generated by modifying the original sample 210. Further, a sample 230 (e.g., a sample from other video) can be determined as a negative sample 230. The sample 210 and sample 220 can be determined as a positive sample pair, and the sample 210 and sample 230 can be determined as a negative sample pair to train the model 130. During the training process, an encoder 240 in the model 130 can output features of the samples 210, 220 and 230, i.e., features 212, 222, and 232, respectively. As shown by an arrow 244, the model 130 can be trained in the direction of pulling closer the distance between the features 212 and 222; as shown by an arrow 242, the model 130 can be trained in the direction of pushing farther the distance between the features 212 and 232. The training process can be iteratively performed with a large number of positive and negative sample pairs.

Various technical solutions have been provided for constructing positive and negative samples. In a BE technical solution, videos other than the positive samples can be directly determined as negative samples. This results in that the contrastive learning model cannot perceive the dynamic information (such as playback speed) of the video content, and a large number of training videos need to be prepared to obtain sufficient negative samples. In a Pace technical solution, the sampling frequency of videos other than positive samples can be adjusted (i.e., variable speed, for example, the sampling frequency can be adjusted from 0.25 seconds per frame to 0.5 seconds per frame, or other values), and the adjusted video can be determined as a negative sample. At this point, the difference between positive samples and negative samples is too obvious, which leads to a decrease in learning difficulty. Therefore, the training effect is unsatisfactory.

In an RSPNet technical solution, the sampling frequency of videos of positive samples can be adjusted, and the adjusted video can be determined as a negative sample. The adjusted video has a different playback speed from the video before the adjustment, which enables the contrastive learning model to distinguish between positive and negative samples in terms of dynamic information. However, positive and negative samples have the same video content (i.e., appearance), which makes it impossible for the contrastive learning model to obtain semantic knowledge about appearance differences.

It will be understood that the construction of negative samples will greatly affect the semantic knowledge obtained during the training process, thereby affecting the accuracy of the contrastive learning model. At this time, it is desirable to generate high-quality negative samples in a simpler and more effective way.

### Summary Process for Generating Negative Samples

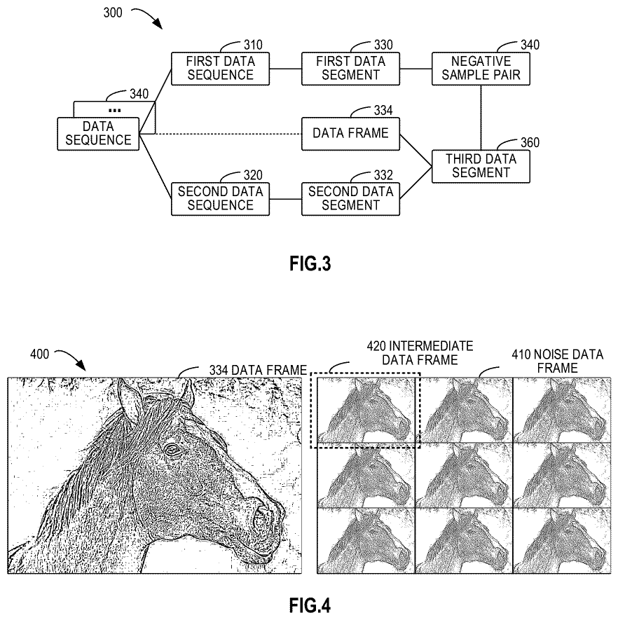

In order to at least partially address the drawbacks described above, a method for generating negative sample pairs of a contrastive learning model is proposed. A summary of an example implementation according to the present disclosure is described with reference to FIG. 3, which shows a block diagram 300 of a process for generating positive sample pairs of a contrastive learning model according to some implementations of the present disclosure. As shown in FIG. 3, a plurality of data sequences 350 for training a contrastive learning model can be obtained. It will be understood that although details of an example implementation according to the present disclosure are described with video sequences as examples of data sequences, alternatively and/or additionally, the data sequences may comprise sequences in other formats. For example, in the context of audio processing applications, the data sequences may comprise audio sequences. In other application scenarios, the data sequences may also comprise sequences such as thermal image sequences, temperature sequences, humidity sequences, or other monitored parameters.

A first data sequence 310 and a second data sequence 320 may be determined from the plurality of data sequences 350, respectively. Here, the two data sequences may each comprise a plurality of data frames, and their resolutions and lengths may be the same or different. Further, a first data segment 330 may be obtained from the first data sequence 310. At this time, the first data segment 330 may comprise a portion of the data frames among the plurality of data frames in the first data sequence 310. The first data segment 330 may have the same length, assuming that the first data sequence comprises N (positive integer) data frames, and the first data segment 330 may comprise n (positive integer) data frames (n<N).

Further, a second data segment 332 may be determined from the second data sequence 320 in the plurality of data sequences 350 in a similar way. The first data segment 330 and the second data segment 332 may have the same length (e.g., comprising n data frames). Moreover, a data frame 334 may be selected from data sequences other than the second data sequence 320 of the plurality of data sequences 340. Here, the data frame 334 will be determined as an interferer, and noise may be added to the generated negative samples, thereby increasing the training difficulty and improving the accuracy of the contrastive learning model.

The data frame 334 may be selected in various ways, for example, the data frame 334 may be randomly selected, data frames at specific locations may be selected, or the data frame 334 may be selected based on the content of a data sequence. A third data segment 360 (i.e., negative sample) may be generated based on the second data segment 332 and the data frame 334. In other words, the data frame 334 may be utilized to modify individual data frames in the second data segment 332 and further generate the third data segment 360. Further, the first data segment 330 and the third data segment 360 may be utilized to determine a negative sample pair 340 for training the contrastive learning model.

In the context of video processing applications, two different video segments may be determined from different video sequence respectively, used as a basis for constructing the negative sample pair, and one of the two video segments may be used as an original video segment and the other used as a negative sample. Further, the appearance of the negative sample can be disturbed with video frames from other video sequences (for example, fusing the content of video frames into respective video frame in the negative sample, i.e., overlapping two video frames). Subsequently, the original video segment and the disturbed negative sample can be determined as a negative sample pair.

It will be understood that at this time, the negative sample is modified based on video frames from other video sequences, so more radical appearance disturbance can be introduced into the negative sample, thereby destroying original information in the negative sample. The video frames from other video sequences usually have different color information, and compared with a technical solution based solely on adjusting the sampling frequency of a video, stronger disturbance can be introduced into a negative sample in terms of appearance, thereby providing a negative sample with richer semantic information. Different video frames can be determined as interference factors and a large number of negative samples can be generated. In this way, more negative samples with richer appearance information can be generated without the need to expand the training sample set, thereby improving the accuracy of the contrastive learning model. Furthermore, the training efficiency and accuracy of downstream models can be improved.

### Detailed Process for Generating Positive Sample Pairs

While the summary of generating a negative sample pair has been described, more details of generating a negative sample pair will be described below with reference to the accompanying drawings. According to an example implementation of the present disclosure, a plurality of data sequences 350 may be selected from a publicly available video sequence set. Further, the first data sequence 310 and the second data sequence 320 may be selected from the plurality of data sequences 350. Two data sequences may be randomly selected, and alternatively and/or additionally, two data sequences may be selected based on the resolution, length, speed and content of the video sequence. Further, the first data segment 330 may be obtained from the first data sequence 310, and the second data segment 332 may be obtained from the second data sequence 320. The first data segment 330 and the second data segment 332 may have the same length.

Generally speaking, various video sequences might have different lengths and might comprise a plurality of shots. Assuming that the first data sequence 310 involves car content and comprises two shots: the car riding on the road (shot 1) and the interior decoration of the car (shot 2). When obtaining the first data segment 330 from the first data sequence 310, it is necessary to select single shot data to avoid that the shot switching causes the first data segment 330 to comprise two shots with weaker correlation and further affects the quality of the sample. For example, the first data segment 330 can be selected from shot 1 (or short 2). The first data segment 330 can be selected from the first data sequence 310 according to a predetermined length. Likewise, the second data segment 332 may be determined from the second data sequence 320. Specifically, the second data segment 332 may be selected from a portion of the second data sequence 320 comprising a single shot according to a predetermined length.

Further, the data frame 334 may be selected from data sequences other than the second data sequence 320 in the plurality of data sequences 340. It will be understood that the data frame 334 herein is used to interfere with the appearance information of the second data segment 332, and therefore it is necessary to select the data frame 334 from data sequences other than the second data sequence 320. In order to further introduce more interference information, the data frame 334 may be selected from a data sequence having a large content difference from the second data sequence 320. At this time, a second data range of each data frame in the second data sequence 320 may be determined. Further, a data range of each data frame in other data sequences in the plurality of data sequences 350 may be determined, and a data sequence having a large data difference from the second data range may be determined by comparison. Subsequently, the data frame 334 may be selected from the data sequence.

Specifically, in the scenario of video sequences, a second color range of a plurality of data frames in the second data sequence 320 can be determined, and a data sequence with a larger color contrast can be selected from the plurality of data sequences 350. Further, the color range of each data sequence in the plurality of data sequences 340 can be determined. If it is determined that the difference between the color range of a certain data sequence and the second color range satisfies a predetermined condition, the data sequence can be selected, and the data frame 333 may be selected therefrom.

Here, the predetermined condition may be determined using pixel values of each video frame in the video sequence. For example, the predetermined condition can indicate that the numerical difference of corresponding pixels in two videos should exceed a predetermined threshold. For example, when the pixel colors in three channels are represented by RGB triples, the predetermined threshold can represent a spatial distance of the pixels in the three channels. Assuming that the second data sequence 320 comprises car videos and the overall color range is blue-gray, for example, a video sequence comprising a color range of reddish-brown can be selected from the plurality of video sequences 350, and the video frame 334 may be selected from this video sequence.

According to an example implementation of the present disclosure, the data frame 334 can be selected based on various ways. For example, any data frame can be randomly selected from the determined data sequence, and a data frame at a specified location (such as a start, center, or end position) can be selected. Since the colors in the two data sequences are different, using the data frame 334 to modify the second data segment 332 can interfere with the original color distribution of the second data segment 332 and increase the learning difficulty, which will help the contrastive learning model obtain more semantic knowledge.

Here, the first data segment 330 may be used as an original data segment and the second data segment 332 as a negative sample. Further, the data frame 334 may be utilized to modify the second data segment 332 so as to introduce more interference information. According to an example implementation of the present disclosure, the data frame 334 can be directly fused to each data frame in the second data segment 332 (i.e., the data frame 334 is superimposed on each data frame) to generate the third data segment 360 as the negative sample. In this way, the data frame 334 will be directly fused to each video frame in the second data segment 332, and the negative sample can comprise richer semantic information, thereby improving the generalization ability of the contrastive learning model. Furthermore, the fusion process only involves simple processing and will not significantly increase the workload of generating negative samples. In this way, the negative sample can be generated in a simple and efficient way.

According to an example implementation of the present disclosure, in order to further enrich the appearance information of the negative sample, high-frequency information can be added to the third data segment 360. Specifically, high-frequency noise data frames can be generated based on the data frame 334, and respective data frames in the second data segment 332 can be updated with the noise data frames. The process of generating a noise data frame is described in FIG. 4, which shows a block diagram 400 of the process for generating the noise data frame according to some implementations of the present disclosure.

As shown in FIG. 4, the data frame 334 represents a data frame used as interference data. Dimensions of the data frame 334 can be adjusted according to a predetermined ratio (for example, reducing a height and width of a video frame to 1/K of the original, for example K=3 or other values) to generate an intermediate data frame 420. The intermediate data frame 420 can be copied, and a plurality of copied intermediate data frames can be generated, and then the plurality of copied intermediate data frames can be joined to generate noise data 410. At this time, the noise data frame 410 will comprise K*K reduced data frames.

It will be understood that although the adjustment of the same ratio is performed in both the height and width dimensions as shown above, alternatively and/or additionally, different adjustment methods can be performed. FIG. 5 shows a block diagram 500 of the process for generating the noise data frame according to some implementations of the present disclosure. As shown in FIG. 5, only the ratio of the height dimension can be adjusted to generate noise data 510. As another example, only the ratio of the width dimension can be adjusted to generate noise data 520. As another example, the height dimension and the width dimension can be adjusted in different proportions to generate noise data frames 530.

It will be understood that although the above shows the case in which the noise data frame comprises intermediate images that are exactly an integer multiple, alternatively and/or additionally, the noise data can comprise intermediate images that are not integer multiples. For example, a noise data frame 540 can comprise 6 complete intermediate data frames and 3 incomplete intermediate data frames.

It will be appreciated that, although the above illustrates a case in which the noise data frame and the data frame in the second data segment 332 have the same resolution, the noise data frame and the data frame may have different resolutions, at which time the noise data frame may be cropped to the resolution of the data frame in the second data segment 332. Alternatively and/or additionally, the noise data frame may be scaled to the resolution of the data frame in the second data segment 332. In this way, it may be ensured that the noise data and each data frame in the second data segment 332 have the same resolution, thereby generating each data frame in the third data segment 360 in a more simple and quick way based on a unified processing method.

In the following, how to generate the noise data frame 410 will be described with a specific formula. Assuming that a symbol X represents the data frame 334, adjustments can be conducted to the height and width dimensions of the data frame 334, so that the height H and width W of the data frame 334 are respectively adjusted to 1/K1 and 1/K2 of the original. At this time, the dimension of the intermediate data frame 420 is H/K1*W/K2. The K1*K2 copied intermediate data frames 410 can be joined to generate the noise data frame 510 of dimension H*W (represented by a symbol D).

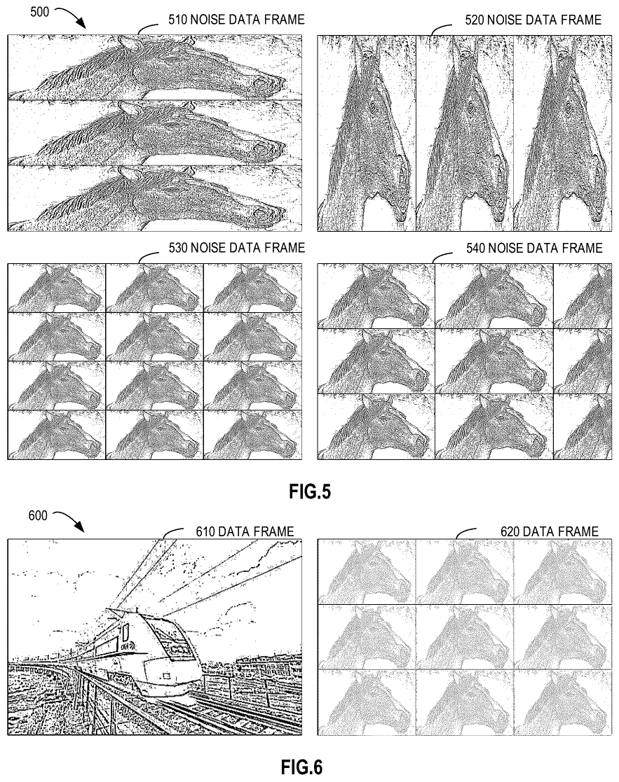

Further, the noise data frame 410 may be fused to respective data frames in the second data segment 332, thereby generating the third data segment 360. According to an example implementation of the present disclosure, each data frame in the second data segment 332 may be updated with the noise data frame 410. FIG. 6 shows a block diagram 600 of the process for generating data frames in the third data segment according to some implementations of the present disclosure. As shown in FIG. 6, only the data frame 610 is described as an example of data frames in the second data segment 332. The data frame 610 may be fused with the noise data frame 410 to generate a data frame 620.

According to an example implementation of the present disclosure, each pixel in the data frame 710 can be determined one by one. For example, assuming that the second data segment 332 is represented by a symbol Vᵢ′ and the j^{th} frame in the second data segment 332 is represented by a symbol Vᵢ′(j), the data frame 710 can be determined based on Formula 1.

V̅ᵢ′(j)=(1−λ)Vᵢ′(j)+λD Formula 1

In Formula 1, the third data segment 360 is represented by V̅ᵢ, pixel data of the j^{th} frame in the third data segment 360 is represented by V̅ᵢ′(j), a predetermined weight of the noise data frame 410 is represented by λ, and pixel data of the noise data frame 510 is represented by D. Each data frame in the second data segment 332 can be processed based on Formula 1 to generate a data frame in the third data segment 360.

Specifically, with respect to a given data point (e.g., a pixel at a position (x,y)) in the data frame 610 in the second data segment 332, a data value (e.g., a pixel value) of the given data point is obtained. Subsequently, a corresponding data value of a data point corresponding to the given data point in the noise data frame 410 can be obtained. Further, a data value of a data point corresponding to the given data point in the data frame 620 can be determined based on the data value, the corresponding data value, and the weight of the noise data frame. In other words, the pixel value of the pixel at the position (x,y) in the synthesized data frame 620 can be determined based on the pixel value of the pixel at the position (x,y) in the data frame 420, the pixel value of the pixel at the position (x,y) in the noise data frame 410, and the weight.

It will be understood that the pixel values can comprise three channels of RGB (red, green, and blue), so the pixel values in each channel can be processed separately, and then the pixel values in each channel in the data frame 620 can be determined. Assuming that the three channels of RGB in the j^{th} frame are respectively represented by Vᵢ′^{R} (j), Vᵢ′^{G} (j), and Vᵢ′^{B} (j), the pixel values of respective channels of the j^{th} frame of the third data segment 360 can be determined based on Formula 2:

V̅ᵢ′^{R}(j)=(1−λ)Vᵢ′^{R}(j)+λD^{R}

V̅ᵢ′^{G}(j)=(1−λ)Vᵢ′^{G}(j)+λD^{G}

V̅ᵢ′^{B}(j)=(1−λ)Vᵢ′^{B}(j)+λD^{B} Formula 2

In Formula 2, pixel data of the three channels of the j^{th} frame in the third data segment 360 is represented respectively by Vᵢ′^{R}(j), Vᵢ′^{G}(j), and Vᵢ′^{B}(j), the predetermined weight of the noise data frame 510 is represented by A, the pixel data of the three channels of the noise data frame 510 is represented respectively by D^{R}, D^{G}, and D^{B}. Each data frame in the second data segment 332 can be processed based on Formula 2 to generate a data frame in the third data segment 360.

For example, a weight λ=50% is used to generate the data frame 620. At this time, the data frame 610 and the noise data frame 410 each contribute 50% to the synthesized data frame 620. According to an example implementation of the present disclosure, a weight λ can be modified to adjust a degree of interference of the noise data frame 410 to respective data frames in the second data segment 332. Specifically, reducing the value of the weight λ can add less noise to the positive sample, and increasing the value of the weight λ can add more noise to the positive sample.

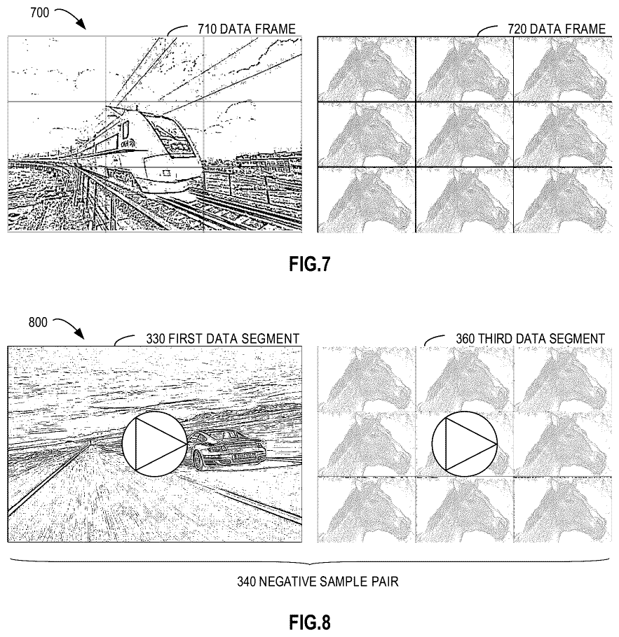

FIG. 7 shows a block diagram 700 of the process for generating data frames in the third data segment according to some implementations of the present disclosure. As shown in FIG. 7, a weight λ=30% is used to generate a data frame 710, and a weight λ=70% is used to generate a data frame 720. As seen from FIG. 7, different weights can adjust the degree of interference of the noise data frame 410 with the data frame 610. A too-small weight can only introduce tiny noise, which may cause the generalization ability of the contrastive learning model insufficient. A too-large weight will introduce a large amount of noise, which may cause the contrastive learning model to ignore dynamic information carried by an original data segment (i.e., an action change relationship between respective data frames), and then introduce uncertain factors into the contrastive learning model. A balance can be stricken between the above two aspects, and a suitable weight can be selected.

FIG. 8 shows a block diagram 800 of the process for generating a negative sample pair according to some implementations of the present disclosure. In the case where the third data segment 360 has been generated, the first data segment 330 and the third data segment 360 may be combined to generate a negative sample pair 340. At this time, the negative sample pair 340 may be used to train a contrastive learning model to push farther the distance between the features of the first data segment 330 and the third data segment 360.

It will be understood that, although only the process of generating one negative sample is described in the foregoing, a plurality of negative samples may be generated in a similar way. Assuming that a data sequence set comprises m data sequences, any one of the m data sequences may be determined as the first data sequence 310 described above, and any one of the remaining m−1 data sequences may be determined as the second data sequence 320 described above. The first data segment 330 may be determined from the first data sequence 310, the second data segment 332 may be determined from the second data sequence 320, and the data frame 334 may be determined from other data sequence. Further, the third data segment 360 can be generated by updating the second data segment 332 with the data frame 334. Subsequently, the first data segment 330 and the third data segment 360 may be combined to generate the negative sample pair 340. In this way, a large number of negative sample pairs may be generated to iteratively update the contrastive learning model.

The process of adding disturbance information to negative samples has been described above. Alternatively and/or additionally, a sampling frequency of the data segment used as a negative sample can be adjusted so as to allow the contrastive learning model to more strongly perceive dynamic information in the sample. FIG. 9 shows a block diagram of a process of adjusting the sampling frequency of a data segment according to some implementations of the present disclosure. As shown in FIG. 9, suppose a data segment 910 is a negative sample and comprises a plurality of data frames, 912, 914, 916, 918, 920, . . . , 922. At this point, a portion of data frames, i.e., the data frames 912, 916, 920, . . . , 920 may be selected from the plurality of data frames in predetermined intervals through “down-sampling,” and a data segment 930 with the sampling frequency being adjusted may be generated.

Compared with the data segment 910, dynamic changes of respective data frames in the data segment 930 will be more significant, which can cause the contrastive learning model to perceive dynamic information in addition to the appearance information of the data frame, thereby enhancing the performance of the contrastive learning model. Specifically, in a video processing scenario, the data segment 930 can be a video with a faster playback speed, which causes the contrastive learning mode to better grasp dynamic changes between respective video frames.

The process of using data segments from different data sequences to construct negative samples has been described above. Alternatively and/or additionally, data segments from the same data sequence may be used to construct negative samples. Specifically, a sampling frequency of a plurality of data frames in the first data sequence 310 may be adjusted so as to generate a fourth data segment. For example, the fourth data segment may be generated from the first data sequence 310 in the way of frame extraction as shown in FIG. 9. At this point, since the fourth data segment has a different appearance and speed from the first data segment 330, the first data segment 330 and the fourth data segment can be combined to determine the negative sample pairs for training the contrastive learning model. In this way, dynamic changes can be introduced into the negative samples, and on the other hand, the number of negative samples can be further increased.

Alternatively and/or additionally, appearance interference can be further introduced into negative samples from the same data sequence. For example, a fifth data segment can be generated based on the fourth data segment and the data frame 334 according to the fusion method described above. Further, negative sample pairs for training the contrastive learning model can be determined based on the first data segment and the fifth data segment. At this time, negative samples from the same data sequence comprise both dynamic information and appearance interference information. In this way, the quantity and quality of samples can be further increased, and the performance of the contrastive learning model can be further improved.

The process of generating negative samples has been described above, and according to an example implementation of the present disclosure, positive samples can be further constructed based on data segments from the same data sequence. For example, a sixth data segment can be determined from the first data sequence 310, and interference can be added to the sixth data segment using the data frame 334 to generate a seventh data segment.

At this time, both the first data segment 330 and the seventh data segment are from the first data sequence 310. However, the seventh data segment comprises interference factors (i.e., information from the data frame 334 is fused). At this time, the first data segment and the seventh data segment can be combined to determine positive sample pairs for training the contrastive learning model. Comprising interference factors from other data sequences in the positive sample can increase the learning difficulty of the positive sample, thereby improving the accuracy of the contrastive learning model in distinguishing positive samples.

With the example implementations of the present disclosure, negative sample pairs and positive sample pairs can be generated in various ways. In summary, positive sample pairs can be generated using data segments from the same data sequence. Table 1 below shows a plurality of data segments from the same data sequence in symbols.

TABLE 1
Data Segments From Data Sequence i

| No. | Symbol | Description |
|---|---|---|
| 1 | Vᵢ | Data segment from a data sequence i |
| 2 | Vᵢ′ | Another data segment from the data sequence i |
| 3 | Vᵢ⁺ | Fused positive sample, i.e., positive |
| | | sample resulting from adding disturbance |
| | | information to the data segment Vᵢ |
| 4 | V_{i(micron)}⁻ | Negative sample resulting from |
| | | adjusting the sampling frequency of |
| | | the data segment Vᵢ′, i.e., |
| | | speed-adjusted negative sample |
| 5 | V_{i(masked+motion)}⁻ | Negative sample resulting from |
| | | adjusting the sampling frequency |
| | | of the data segment Vᵢ⁺, i.e., |
| | | fused and speed-adjusted negative sample |

Further, negative sample pairs can be generated using data segments from different data sequences. For example, for either of two data segments from different data sequences, interference information can be added to the data segment based on the formula described above to adjust the appearance information of the sample. Alternatively and/or additionally, the sampling frequency of the data segment can be modified to adjust the dynamic information of the sample. Alternatively and/or additionally, both of the above operations can be performed to adjust both the appearance information and dynamic information of the sample. Table 2 below shows a plurality of data segments from different data sequences in symbols.

TABLE 2
Data Segments From Data Sequence j

| No. | Symbol | Description |
|---|---|---|
| 1 | V_{j≠i} | Data segment from |
| | | a data sequence j |
| 2 | V_{j≠i}⁺ | Fused data segment from |
| | | the data sequence j |
| 3 | V_{j≠i(motion)}⁻ | Speed-adjusted data segment |
| | | from the data sequence j |
| 4 | V_{j≠i(masked+motion)}⁻ | Fused and speed-adjusted data |
| | | segment from the data sequence j |

According to an example implementation of the present disclosure, the positive sample can comprise Vᵢ⁺. The negative sample can comprise data segments Vᵢ₍ₘₒₜᵢₒₙ₎⁻ and V_{i(masked+motion)}⁻ from the same data sequence. In other words, the data segments from the same data sequence can be used as negative samples after a speed-adjusted operation. Alternatively and/or additionally, the negative sample can also comprise data segments V_{j≠i}, V_{j≠i}⁺, V_{j≠i(motion)}⁻, and V_{j≠i(masked+motion)}⁻ from different data sequences. In other words, data segments from different data sequences can be used as negative samples, and in order to improve information richness of negative samples, image fusion, speed adjusting, or image fusion and speed adjusting can be performed for data segments from different data sequences.

According to an example implementation of the present disclosure, positive and negative sample pairs can be constructed respectively by using the respective data segments shown above. For example, the positive sample pair may comprise: (Vᵢ, Vᵢ⁺). The negative sample pair may comprise (Vᵢ,Vᵢ₍ₘₒₜᵢₒₙ₎⁻), (Vᵢ,V_{i(masked+motion)}⁻), (Vᵢ,V_{j≠i}), (Vᵢ,V_{j≠i}⁺), (Vᵢ,V_{j≠i(motion)}⁻), (Vᵢ,V_{j≠i(masked+motion)}⁻). With the example implementation of the present disclosure, positive sample pairs and negative sample pairs comprising rich semantic information may be constructed.

Furthermore, the contrastive learning model can be trained using the positive sample pairs and negative sample pairs described above. In this way, positive sample pairs can pull closer the features between positive samples, and negative sample pairs can push farther the features between negative samples. In this way, the accuracy of the contrastive learning model can be improved.

According to an example implementation of the present disclosure, the effect of training the contrastive learning model with the provided technical solution can be verified under a plurality of public datasets (e.g., video datasets UCF101 and Kinetics-400). Table 3 below shows evaluation results in downstream scenarios using a full fine-tuning and linear evaluation. Here, the full fine-tuning and linear evaluation are two forms used for downstream task training, wherein the full fine-tuning means that trained model parameters directly participate in a full-parameter fine-tuning training in downstream tasks, and the linear evaluation represents that only a last fully connected layer is adjusted, and other parameters are fixed.

TABLE 3
Accuracy of Contrastive Learning Model
Trained With Different Samples

| | | | Fine-tuning | | Linear eval. | |
|---|---|---|---|---|---|---|
| AD-Pos | Intra-Neg | AD-Intra-Neg | UCF | HMDB | UCF | HMDB |

Pre-trained on UCF101 dataset

| | | | | | | |
|---|---|---|---|---|---|---|
| — | — | — | 76.0 | 44.3 | 68.8 | 33.6 |
| ✓ | — | — | 78.2 | 47.2 | 70.0 | 37.0 |
| ✓ | ✓ | — | 79.6 | 49.3 | 71.5 | 38.8 |
| ✓ | ✓ | ✓ | 80.9 | 51.0 | 73.9 | 40.3 |

Pre-trained on K400 dataset

| | | | | | | |
|---|---|---|---|---|---|---|
| — | — | — | 80.9 | 50.2 | 75.0 | 44.3 |
| ✓ | — | — | 82.1 | 53.6 | 76.2 | 47.4 |
| ✓ | ✓ | — | 84.5 | 55.0 | 77.3 | 48.4 |
| ✓ | ✓ | ✓ | 85.6 | 56.2 | 79.2 | 50.1 |

In Table 3, UCF and HMDB represent different datasets. “AD-Pos” represents the technical solution of generating positive samples based on image fusion of data segments in the same video described above, Intra-Neg represents the technical solution of generating negative samples based on speed adjusting of data segments in the same video, and AD-Intra-Neg represents the technical solution of generating negative samples based on image fusion and speed adjusting of data segments in the same video.

For example, in the scenario of pre-training on the UCF101 dataset, when performing a full fine-tuning operation on the UCF dataset, the model accuracy is 76.0% without generating negative samples using the method of the present disclosure. When using the AD-Pos technical solution, the accuracy is increased to 78.2%; when using the AD-Pos and Intra-Neg technical solutions, the accuracy is increased to 79.6%; when using the AD-Pos, Intra-Neg, and AD-Intra-Neg technical solutions, the accuracy is increased to 80.9%. As shown in Table 3, the above three methods of generating negative samples can improve the accuracy of the contrastive learning model.

It will be understood that although the process of generating sample pairs has been described above with only video sequences as examples of data sequences, alternatively and/or additionally, the data sequences may also comprise sequences such as audio sequences, thermal image sequences, temperature sequences, humidity sequences, or other monitored parameters. Specifically, in the case of processing audio data, the audio data can be sampled at a predetermined frequency and an audio data sequence at a predetermined sampling point can be generated. The audio data sequence can be processed in the manner described above to generate corresponding positive sample pairs.

With the example implementations of the present disclosure, more noise information can be added to the samples and more aggressive interference can be achieved. For example, the high-frequency information in the joined noise data frame can increase the difficulty of the contrastive learning model in identifying samples. In this way, the contrastive learning model can learn more about the semantic information in each sample pair, thus learning richer semantic knowledge.

### Example Process

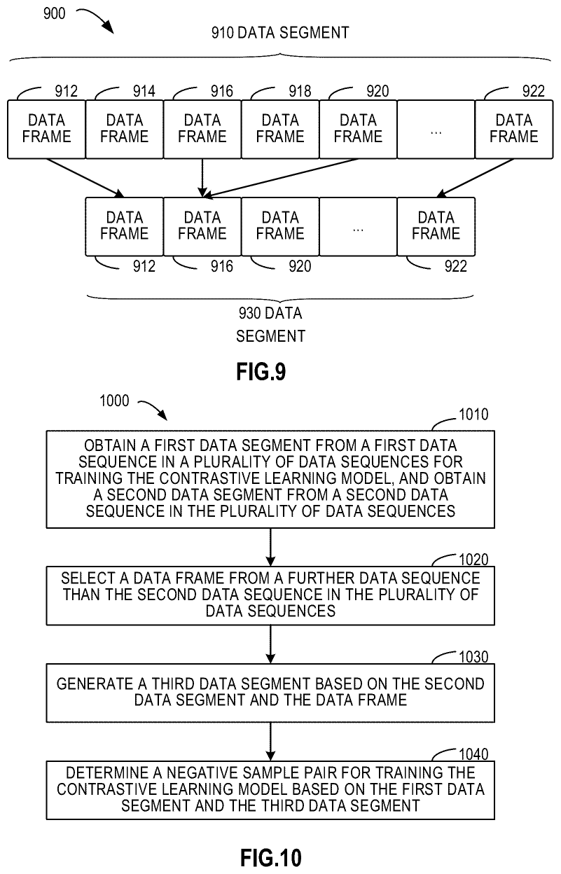

The specific process of generating samples has been described above. Hereinafter, the corresponding method is described with reference to FIG. 10. FIG. 10 shows a flowchart of a method 1000 for generating negative sample pairs for a contrastive learning model in accordance with some embodiments of the present disclosure. At a block 1010, a first data segment is obtained from a first data sequence in a plurality of data sequences for training the contrastive learning model, and a second data segment is obtained from a second data sequence in the plurality of data sequences. At a block 1020, a data frame is selected from a further data sequence than the second data sequence in the plurality of data sequences. At a block 1030, a third data segment is generated based on the second data segment and the data frame. At a block 1040, a negative sample pair for training the contrastive learning model is determined based on the first data segment and the third data segment.

According to an exemplary implementation of the present disclosure, generating the third data segment comprises: generating a noise data frame based on the data frame; and updating a data frame in the second data segment with the noise data frame.

According to an exemplary implementation of the present disclosure, generating the noise data frame comprises: generating an intermediate data frame by adjusting dimensions of the data frame according to a predetermined ratio; generating a plurality of copied intermediate data frames by copying the intermediate data frame; and generating the noise data by joining the plurality of copied intermediate data frames.

According to an exemplary implementation of the present disclosure, the dimensions of the data frame comprise at least one of a width and a height.

According to an exemplary implementation of the present disclosure, the method 1000 further comprising: in response to determining that a resolution of the noise data frame is different from that of the data frame in the second data segment, performing at least one of: cropping the noise data frame to the resolution of the data frame in the second data segment; scaling the noise data frame to the resolution of the data frame in the second data segment.

According to an exemplary implementation of the present disclosure, updating the data frame in the second data segment with the noise data frame comprises: for a given data point in the data frame in the second data segment, obtaining a data value of the given data point; obtaining a corresponding data value of a data point in the noise data frame corresponding to the given data point; and determining a data value of a data point in the data frame corresponding to the given data point based on the data value, the corresponding data value, and a weight of the noise data frame.

According to an exemplary implementation of the present disclosure, obtaining the first data segment comprises: selecting the first data segment satisfying a predetermined length from the first data sequence, the first data segment comprising only a single shot.

According to an exemplary implementation of the present disclosure, obtaining the second data segment comprises: selecting the second data segment satisfying the predetermined length from the second data sequence, the second data segment comprising only a single shot.

According to an exemplary implementation of the present disclosure, the method 1000 further comprising: determining a data range of a plurality of data frames in the second data sequence; determining a given data range of a plurality of data frames in a given data sequence in the further data sequence; and in response to determining that a difference between the data range and the given data range satisfies a predetermined condition, selecting the data frame from the given data sequence.

According to an exemplary implementation of the present disclosure, generating the third data segment further comprising: adjusting a sampling frequency of a plurality of data frames in the third data segment.

According to an exemplary implementation of the present disclosure, the method 1000 further comprising: generating a fourth data segment by adjusting the sampling frequency of a plurality of data frames in the first data sequence; and determining a negative sample pair for training the contrastive learning model based on the first data segment and the fourth data segment.

According to an exemplary implementation of the present disclosure, the method 1000 further comprising: generating a fifth data segment based on the fourth data segment and the data frame; and determining a negative sample pair for training the contrastive learning model based on the first data segment and the fifth data segment.

According to an exemplary implementation of the present disclosure, the method 1000 further comprising: obtaining a sixth data segment from the first data sequence; generating a seventh data segment based on the sixth data segment and the data frame; and determining a positive sample pair for training the contrastive learning model based on the first data segment and the seventh data segment.

According to an exemplary implementation of the present disclosure, the method further comprising: training the contrastive learning model with the positive sample pair and the negative sample pair.

### Example Apparatus and Equipment

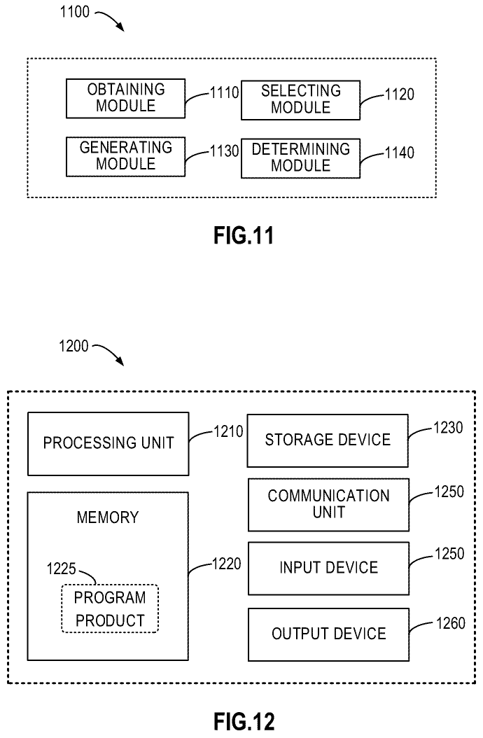

FIG. 11 shows a block diagram of an apparatus 1100 for generating negative sample pairs for a contrastive learning model in accordance with some implementations of the present disclosure. The apparatus 1100 comprises: an obtaining module 1110, configured to obtain a first data segment from a first data sequence in a plurality of data sequences for training the contrastive learning model, and obtain a second data segment from a second data sequence in the plurality of data sequences; a selecting module 1120, configured to select a data frame from a further data sequence than the second data sequence in the plurality of data sequences; a generating module 1130, configured to generate a third data segment based on the second data segment and the data frame; and a determining module 1140, configured to determine a negative sample pair for training the contrastive learning model based on the first data segment and the third data segment.

According to an exemplary implementation of the present disclosure, the generating module 1130 comprises: a noise generating module, configured to generate a noise data frame based on the data frame; and an updating module, configured to update a data frame in the second data segment with the noise data frame.

According to an exemplary implementation of the present disclosure, the noise generating module comprises: an adjusting module, configured to generate an intermediate data frame by adjusting dimensions of the data frame according to a predetermined ratio; a copying module, configured to generate a plurality of copied intermediate data frames by copying the intermediate data frame; and a joining module, configured to generate the noise data by joining the plurality of copied intermediate data frames.

According to an exemplary implementation of the present disclosure, the dimensions of the data frame comprise at least one of a width and a height.

According to an exemplary implementation of the present disclosure, the apparatus 1100 further comprises: a cropping module, configured to, in response to determining that a resolution of the noise data frame is different from that of the data frame in the second data segment, crop the noise data frame to the resolution of the data frame in the second data segment.

According to an exemplary implementation of the present disclosure, the apparatus 1100 further comprises: a cropping module, configured to, in response to determining that a resolution of the noise data frame is different from that of the data frame in the second data segment, scale the noise data frame to the resolution of the data frame in the second data segment.

According to an exemplary implementation of the present disclosure, the updating module comprises: a data value obtaining module, configured to, for a given data point in the data frame in the second data segment, obtain a data value of the given data point; a corresponding value obtaining module, configured to obtain a corresponding data value of a data point in the noise data frame corresponding to the given data point; and a data value determining module, configured to determine a data value of a data point in the data frame corresponding to the given data point based on the data value, the corresponding data value, and a weight of the noise data frame.

According to an exemplary implementation of the present disclosure, the obtaining module 1110 comprises: a first data segment selecting module, configured to select the first data segment satisfying a predetermined length from the first data sequence, the first data segment comprising only a single shot.

According to an exemplary implementation of the present disclosure, the obtaining module 1110 comprises: a second data segment selecting module, configured to select the second data segment satisfying the predetermined length from the second data sequence, the second data segment comprising only a single shot.

According to an exemplary implementation of the present disclosure, the apparatus 1100 further comprises: a first data range determining module, configured to determine a data range of a plurality of data frames in the second data sequence; a second data range determining module, configured to determine a given data range of a plurality of data frames in a given data sequence in the further data sequence; and a data frame selecting module, configured to, in response to determining that a difference between the data range and the given data range satisfies a predetermined condition, select the data frame from the given data sequence.

According to an exemplary implementation of the present disclosure, the generating module 1130 further comprises: an adjusting module, configured to adjust a sampling frequency of a plurality of data frames in the third data segment.

According to an exemplary implementation of the present disclosure, the generating module 1130 further comprises: a sampling frequency adjusting module, configured to generate a fourth data segment by adjusting the sampling frequency of a plurality of data frames in the first data sequence; and the determining module 1140 is further configured to determine negative sample pair for training the contrastive learning model based on the first data segment and the fourth data segment.

According to an exemplary implementation of the present disclosure, the generating module 1130 is further configured to generate a fifth data segment based on the fourth data segment and the data frame; and the determining module 1140 is further configured to determine a negative sample pair for training the contrastive learning model based on the first data segment and the fifth data segment.

According to an exemplary implementation of the present disclosure, the obtaining module 1110 is further configured to obtain a sixth data segment from the first data sequence; the generating module 1130 is further configured to generate a seventh data segment based on the sixth data segment and the data frame; and the determining module 1140 is further configured to determine a positive sample pair for training the contrastive learning model based on the first data segment and the seventh data segment.

According to an exemplary implementation of the present disclosure, the apparatus 1100 further comprises: a training module, configured to train the contrastive learning model with the positive sample pair and the negative sample pair.

FIG. 12 shows an electronic device 1200 in which one or more implementations of the present disclosure may be implemented. It would be understood that the electronic device 1200 shown in FIG. 12 is only an example and should not constitute any restriction on the function and scope of the implementations described herein.

As shown in FIG. 12, the electronic device 1200 is in the form of a general computing device. The components of the electronic device 1200 may comprise but are not limited to, one or more processors or processing units 1210, a memory 1220, a storage device 1230, one or more communication units 1240, one or more input devices 1250, and one or more output devices 1260. The processing unit 1210 may be an actual or virtual processor and can execute various processes according to the programs stored in the memory 1220. In a multiprocessor system, a plurality of processing units execute computer executable instructions in parallel to improve the parallel processing capability of the electronic device 1200.

The electronic device 1200 typically comprises a variety of computer storage medium. Such medium may be any available medium that is accessible to the electronic device 1200, comprising but not limited to volatile and non-volatile medium, removable, and non-removable medium. The memory 1220 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 1230 may be any removable or non-removable medium and may comprise a machine-readable medium, such as a flash drive, a disk, or any other medium, which can be used to store information and/or data (such as training data for training) and can be accessed within the electronic device 1200.

The electronic device 1200 may further comprise additional removable/non-removable, volatile/non-volatile storage medium. Although not shown in FIG. 12, a disk driver for reading from or writing to a removable, non-volatile disk (such as a “floppy disk”), and an optical disk driver for reading from or writing to a removable, non-volatile optical disk can be provided. In these cases, respective driver may be connected to the bus (not shown) by one or more data medium interfaces. The memory 1220 may comprise a computer program product 1225, which has one or more program modules configured to perform various methods or acts of various implementations of the present disclosure.

The communication unit 1240 communicates with a further computing device through the communication medium. In addition, functions of components in the electronic device 1200 may be implemented by a single computing cluster or a plurality of computing machines, which can communicate through a communication connection. Therefore, the electronic device 1200 may be operated in a networking environment with a logical connection with one or more other servers, a network personal computer (PC), or another network node.

The input device 1250 may be one or more input devices, such as a mouse, a keyboard, a trackball, etc. The output device 1260 may be one or more output devices, such as a display, a speaker, a printer, etc. The electronic device 1200 may also communicate with one or more external devices (not shown) through the communication unit 1240 as required. The external device, such as a storage device, a display device, etc., communicates with one or more devices that enable users to interact with the electronic device 1200, or communicate with any device (for example, a network card, a modem, etc.) that makes the electronic device 1200 communicate with one or more other computing devices. Such communication may be executed via an input/output (I/O) interface (not shown).

According to the example implementation of the present disclosure, a computer-readable storage medium is provided, on which a computer-executable instruction or computer program is stored, wherein the computer-executable instructions or the computer program is executed by the processor to implement the method described above.

According to the example implementation of the present disclosure, a computer program product is also provided. The computer program product is physically stored on a non-transient computer-readable medium and comprises computer-executable instructions, which are executed by the processor to implement the method described above.

Various aspects of the present disclosure are described herein with reference to the flow chart and/or the block diagram of the method, the device, the equipment, and the computer program product implemented according to the present disclosure. It would be understood that respective block of the flowchart and/or the block diagram and the combination of respective blocks in the flowchart and/or the block diagram may be implemented by computer-readable program instructions.

These computer-readable program instructions may be provided to the processing units of general-purpose computers, special computers, or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device, and/or other devices to work in a specific way. Therefore, the computer-readable medium containing the instructions comprises a product, which comprises instructions to implement various aspects of the functions/acts specified in one or more blocks in the flowchart and/or the block diagram.

The computer-readable program instructions may be loaded onto a computer, other programmable data processing apparatus, or other devices, so that a segment of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions, and operations of the system, the method, and the computer program product implemented according to the present disclosure. In this regard, respective block in the flowchart or the block diagram may represent a part of a module, a program segment, or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that respective block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Respective implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application, or improvement of technology in the market of respective implementation, or to enable other ordinary skills in the art to understand the various implementations disclosed herein.

1. A method of generating a negative sample pair of a contrastive learning model, comprising:
obtaining a first data segment from a first data sequence in a plurality of data sequences for training the contrastive learning model, and obtaining a second data segment from a second data sequence in the plurality of data sequences;
selecting a data frame from a further data sequence than the second data sequence in the plurality of data sequences;
generating a third data segment based on the second data segment and the data frame; and
determining a negative sample pair for training the contrastive learning model based on the first data segment and the third data segment.

2. The method of claim 1, wherein generating the third data segment comprises:
generating a noise data frame based on the data frame; and
updating a data frame in the second data segment with the noise data frame.

3. The method of claim 2, wherein generating the noise data frame comprises:
generating an intermediate data frame by adjusting dimensions of the data frame according to a predetermined ratio;
generating a plurality of copied intermediate data frames by copying the intermediate data frame; and
generating the noise data by joining the plurality of copied intermediate data frames.

4. The method of claim 3, wherein the dimensions of the data frame comprise at least one of a width and a height.

5. The method of claim 3, further comprising: in response to determining that a resolution of the noise data frame is different from that of the data frame in the second data segment, performing at least one of:
cropping the noise data frame to the resolution of the data frame in the second data segment;
scaling the noise data frame to the resolution of the data frame in the second data segment.

6. The method of claim 2, wherein updating the data frame in the second data segment with the noise data frame comprises: for a given data point in the data frame in the second data segment,
obtaining a data value of the given data point;
obtaining a corresponding data value of a data point in the noise data frame corresponding to the given data point; and
determining a data value of a data point in the data frame corresponding to the given data point based on the data value, the corresponding data value, and a weight of the noise data frame.

7. The method of claim 1, wherein obtaining the first data segment comprises: selecting the first data segment satisfying a predetermined length from the first data sequence, the first data segment comprising only a single shot.

8. The method of claim 7, wherein obtaining the second data segment comprises: selecting the second data segment satisfying the predetermined length from the second data sequence, the second data segment comprising only a single shot.

9. The method of claim 1, further comprising:
determining a data range of a plurality of data frames in the second data sequence;
determining a given data range of a plurality of data frames in a given data sequence in the further data sequence; and
in response to determining that a difference between the data range and the given data range satisfies a predetermined condition, selecting the data frame from the given data sequence.

10. The method of claim 1, wherein generating the third data segment further comprising: adjusting a sampling frequency of a plurality of data frames in the third data segment.

11. The method of claim 1, further comprising:
generating a fourth data segment by adjusting the sampling frequency of a plurality of data frames in the first data sequence; and
determining a negative sample pair for training the contrastive learning model based on the first data segment and the fourth data segment.

12. The method of claim 11, further comprising:
generating a fifth data segment based on the fourth data segment and the data frame; and
determining a negative sample pair for training the contrastive learning model based on the first data segment and the fifth data segment.

13. The method of claim 1, further comprising:
obtaining a sixth data segment from the first data sequence;
generating a seventh data segment based on the sixth data segment and the data frame; and
determining a positive sample pair for training the contrastive learning model based on the first data segment and the seventh data segment.

14. The method of claim 13, further comprising: training the contrastive learning model with the positive sample pair and the negative sample pair.

15. (canceled)

16. An electronic device, comprising:
at least one processing unit; and
at least one memory coupled to the at least one processing unit and storing instructions to be executed by the at least one processing unit, the instructions, when executed by the at least one processing unit, causing the electronic device to perform a method of generating a negative sample pair of a contrastive learning model, the method comprising:
obtaining a first data segment from a first data sequence in a plurality of data sequences for training the contrastive learning model, and obtaining a second data segment from a second data sequence in the plurality of data sequences;
selecting a data frame from a further data sequence than the second data sequence in the plurality of data sequences;
generating a third data segment based on the second data segment and the data frame; and
determining a negative sample pair for training the contrastive learning model based on the first data segment and the third data segment.

17. A non-transitory computer-readable storage medium having a computer program stored thereon, the computer program, when executed by a processor, implementing a method of generating a negative sample pair of a contrastive learning model, the method comprising:
obtaining a first data segment from a first data sequence in a plurality of data sequences for training the contrastive learning model, and obtaining a second data segment from a second data sequence in the plurality of data sequences;
selecting a data frame from a further data sequence than the second data sequence in the plurality of data sequences;
generating a third data segment based on the second data segment and the data frame; and
determining a negative sample pair for training the contrastive learning model based on the first data segment and the third data segment.

18. The device of claim 16, wherein generating the third data segment comprises:
generating a noise data frame based on the data frame; and
updating a data frame in the second data segment with the noise data frame.

19. The device of claim 18, wherein generating the noise data frame comprises:
generating an intermediate data frame by adjusting dimensions of the data frame according to a predetermined ratio;
generating a plurality of copied intermediate data frames by copying the intermediate data frame; and
generating the noise data by joining the plurality of copied intermediate data frames.

20. The device of claim 19, wherein the dimensions of the data frame comprise at least one of a width and a height.

21. The device of claim 19, further comprising: in response to determining that a resolution of the noise data frame is different from that of the data frame in the second data segment, performing at least one of:
cropping the noise data frame to the resolution of the data frame in the second data segment;
scaling the noise data frame to the resolution of the data frame in the second data segment.
